(19) United States
(12) Patent Application Publication
(10) Pub. No.: US 2026/0348863 A1
(43) Pub. Date: Nov. 5, 2026

(54) NON-IMAGING CONCENTRATOR UNIT, ILLUMINATION DEVICE AND INSPECTION SYSTEM

(71) Applicant: ISRA VISION GMBH, Darmstadt (DE)

(72) Inventors: Marc HEMSENDORF, München (DE); Andreas KRAHN, Zeuthen (DE); Wolfgang PRESTEL, München (DE)

(21) Appl. No.: 19/123,631

(22) PCT Filed: Oct. 19, 2023
(86) PCT No.: PCT/EP2023/079133

§ 371 Date: Apr. 23, 2025

(30) Foreign Application Priority Data
Oct. 26, 2022 (DE) 10 2022 128 294.5

(51) Int. Cl. G01N 21/88; G01N 21/89

(52) U.S. Cl. CPC G01N 21/8806; G01N 21/8901; G01N 2021/8908; G01N 2201/062; G01N 2201/0636

(57) ABSTRACT

An inspection system for inspecting an object using an illumination device including a light source and a concentrator unit. The nonimaging concentrator unit comprises a first two-dimensional nonimaging concentrator having a first inlet opening and a first outlet opening, and a second two-dimensional nonimaging concentrator having a second inlet opening, the cross section of which comprises a first section and an adjacent second section, and a second outlet opening. Along the direction of propagation of light the first concentrator in the incident light scattering configuration and the second concentrator in the incident light collecting configuration are arranged one after the other. The second concentrator-is arranged behind the first concentrator in such a way that the light exiting from the first outlet opening enters the second inlet opening in the area of the first section, wherein an optical observation path extends through the second section of the second inlet opening and the second outlet opening.

The invention relates to an inspection system that works with a line scan camera and an illumination device for same.

In quality assurance, line-shaped inspection of objects is often carried out to analyze the objects quickly over a large width. For this, line scan cameras are used, which are oriented to the object to be examined and generate line-by-line image recordings of the object, wherein, for example, the object moves under the line scan camera.

Until now, the illumination of objects inspected by means of a line scan camera has been carried out using imaging optics, since a distance between the light source and the object is required. The imaging optics project a line of light onto the object and the line scan camera observes the area of the object onto which the line of light is projected. With imaging optics, a high radiation density may be achieved on the object in a small area. However, the disadvantage of imaging optics is that only a small proportion of the performance emitted by the light source can be used for the inspection task. This disadvantage applies in particular to light sources that correspond to a Lambertian radiator.

The object of the present invention is therefore to provide an inspection system in which the radiated performance of a light source is used more efficiently, i.e. a higher level of efficiency is achieved, wherein the object is to be inspected using a camera.

The above task is solved by a concentrator unit with the features of claim 1, by an illumination device with the features of claim 10, and by an inspection system with the features of claim 12.

In particular, the above object is achieved by a nonimaging concentrator unit comprising a first two-dimensional nonimaging concentrator having a first inlet opening and a first outlet opening, and a second two-dimensional nonimaging concentrator having a second inlet opening, the cross section of which comprises a first section and an adjacent second section, and a second outlet opening, wherein along the direction of propagation of the light the first concentrator in a the incident light scattering configuration and the second concentrator in a the incident light collecting configuration are arranged one after the other, wherein the second concentrator is arranged behind the first concentrator in such a way that the light exiting from the first outlet opening enters the second inlet opening in the area of the first section, wherein an optical observation path, for example for a camera, extends through the second section of the second inlet opening and the second outlet opening.

The above concentrator unit is composed of two nonimaging concentrators. A nonimaging concentrator is an elemental component of nonimaging optics (also referred to as illuminating optics), which is concerned with the illumination of an object. The concentrator comprises an inlet opening and an outlet opening for the light. The light falling into the inlet opening from a certain angular range is deflected by the concentrator's internal light-deflecting devices (reflecting surfaces or light-transparent bodies) and directed along an optical axis to the outlet opening. The light then exits the concentrator through the outlet opening. In principle, the concentrator may be arranged in two configurations. In a light-collecting configuration, the light entering the inlet opening is deflected in such a way that the overall result at the outlet opening is a collection of light, i.e. the light is deflected in the direction of the optical axis or the centre of the light beam, respectively. In a light-scattering configuration, the light entering the inlet opening of the concentrator is deflected in such a way that, overall, the light is scattered at the outlet opening, i.e. the light is deflected away from the optical axis and from the centre of the light beam.

The two nonimaging concentrators may be arranged directly one after the other in the direction of propagation of the light. The light emitted by a light source enters the first inlet opening of the first concentrator and passes through the first concentrator and through the first outlet opening directly into the second inlet opening of the second concentrator (i.e. the first outlet opening forms a portion of the second inlet opening). In this embodiment, the second concentrator is arranged directly behind the first concentrator in the direction of propagation of the light, for example, in such a way that the first concentrator overlaps with the second inlet opening in the first section of the second inlet opening. Alternatively, the light exiting from the first outlet opening may be directed into the second inlet opening via a light guide arranged between the first concentrator and the second concentrator. In both cases, the light is then directed to the second outlet opening by the second concentrator, where the light exits the concentrator unit. The exiting light illuminates a predetermined inspection area of an object that is located behind the second outlet opening of the second concentrator in the direction of the propagating light.

In both of the above cases in which the second concentrator is located behind the first concentrator, the first section of the second inlet opening of the second concentrator is closed to the outside, so that no light exiting from the first outlet opening of the first concentrator can escape from the concentrator unit and thus this light remains in the concentrator unit. In contrast, the second section of the second inlet opening is open to the outside, so that an observer (e.g. a camera) may observe the inspection area of the object via the optical observation path described in more detail below.

In the concentrator unit, the first concentrator and the second concentrator are arranged in opposite directions in the optical sense with regard to their light focusing. Furthermore, the described properties of the light focusing refer to each cross-sectional area that runs perpendicular to the transverse direction (the transverse direction corresponds to the direction of the largest dimension of the line-shaped illumination). The first concentrator is arranged in a configuration that scatters the incoming light, while the second concentrator is used in a configuration that collects the incoming light. By placing the two concentrators in series along the light path (optionally, as described above, with an intermediate light guide), the first concentrator scatters the incoming light from the light source and the second concentrator collects the incoming light from the first concentrator. Since further light may enter the second concentrator through the second section of the second inlet opening of the second concentrator, this light is also collected by the second concentrator.

Furthermore, with regard to the concentrator unit according to the invention, it is noteworthy that, with respect to a cross-section through the concentrator unit, the second inlet opening, i.e. the inlet opening of the second concentrator, is larger than the first outlet opening, i.e. the outlet opening of the first concentrator or of a corresponding light guide. In other words, the diameter of the second inlet opening in the direction of the cross-section is greater than the sum of the diameter of the first outlet opening and the wall thickness of the first concentrator or than the corresponding dimension of the light guide, respectively. The area of the second inlet opening that remains free due to this difference (i.e. the second section of the second inlet opening) forms an opening for the optical observation path described in more detail below. The first concentrator or light guide, respectively, overlaps the second inlet opening only in the first section, and the light exiting from the first concentrator in this section passes directly or via a light guide into the second concentrator. The second section of the second inlet opening, which is adjacent to the first section, forms a through-going opening that is accessible from outside the concentrator unit and extends laterally to the path of the light coming from the first concentrator and into the interior of the second concentrator. This opening in the second section of the second inlet opening creates an optical observation path or pathway that runs through the second concentrator to the second outlet opening, i.e. the outlet opening of the second concentrator. An observer, for example a camera, may observe the object located behind the second outlet opening (i.e. behind the second concentrator) along this observation path (with respect to the propagation direction of the light). In particular, the observer may observe the predetermined illuminated inspection area illuminated by means of the light source and the concentrator unit. The second section or opening, respectively, for the optical observation path may have a diameter ranging from 3 mm to 30 mm, e.g. from 5 mm to 20 mm, in the direction of the cross-section. Examples of the dimension of the second section of the second inlet opening in the transverse direction (i.e. perpendicular to the cross-section) are described below. The second section of the second inlet opening may therefore, for example, be rectangular or slit-shaped.

In an advantageous way, the concentrator unit according to the invention therefore, on the one hand, causes that the output/performance of the light source is transmitted with a very high efficiency to a desired area, namely to the inspection area of an object arranged behind the concentrator unit. In addition, the concentrator unit according to the invention makes it possible to observe the inspection area in a simple manner that is favorable for the spatial arrangement of a camera. The concentrator unit is thus suitable for use in a variety of inspection tasks, for example for the inspection of surfaces of printed circuit boards, wafers and solar cells, glass surfaces, mirror surfaces, foils, printed matter, metals or the like.

In one embodiment, the nonimaging concentrator unit is configured in a line-shaped manner such that the first inlet opening, the first outlet opening, the second inlet opening and the second outlet opening each comprise a corresponding slit shape extending in a transverse direction. The respective slit shape of the respective opening is characterized by the fact that it has the largest dimension in the transverse direction, while the opening has a significantly smaller dimension in a direction perpendicular to the transverse direction (i.e. the cross section). The structure of the concentrator unit is identical in the transverse direction, i.e. all cross sections through the concentrator unit that extend perpendicular to the transverse direction are identical. For example, the dimension of the openings in the transverse direction may be several centimetres to a few metres, whereas the openings perpendicular to this transverse direction are only a few millimetres wide. For example, the first inlet opening, the second section of the second inlet opening and the second outlet opening have a length in the transverse direction ranging from 200 mm to 500 mm. The first inlet opening has a dimension perpendicular to the transverse direction ranging from 1 mm to 12 mm and of, for example, 5 mm. The second outlet opening has a dimension perpendicular to the transverse direction ranging from 3 mm to 20 mm and of, for example, 13 mm.

In one embodiment, the first concentrator and the second concentrator comprise reflective surfaces (mirror surfaces) and/or transparent bodies as the light-deflecting devices. For example, the reflective surface may be an aluminium layer vapour-deposited onto a corresponding support. Alternatively, the light-deflecting device may also be designed as a transparent body (e.g. glass or Plexiglas), which is designed in such a way that a corresponding light deflection is generated in the concentrator by means of total internal reflection at at least one outer edge.

In one embodiment, at least one concentrator of the first concentrator and the second concentrator is configured as a Compound Elliptical Concentrator (CEC) or as a Compound Parabolic Concentrator (CPC). A CEC is composed of opposing elliptical reflecting surfaces and a CPC is composed of opposing parabolic reflecting surfaces. In particular, the use of at least one concentrator in the form of a CPC, e.g. the use of a first concentrator as a CPC and a second concentrator as a CPC, ensures that a particularly high degree of efficiency in terms of illumination performance is achieved. In addition, the efficiency may be further raised if a Lambertian radiator (e.g. a row of LEDs adjacently arranged in the transverse direction without an optical head) is used as the illumination device for such a concentrator unit with two CPCs and the light source is arranged in the area of the first inlet opening of the first concentrator. Alternatively, if the light source is arranged at a distance from the inlet opening, additionally an optical head may be used to focus the light onto the first inlet opening.

In one embodiment, the first concentrator is arranged adjacent to the second concentrator in such a way that a first tangent at a first point of contact on an inner concentrator mirror surface of the first concentrator and a second tangent at a second point of contact on an inner concentrator mirror surface of the second concentrator are superimposed. In such an arrangement, the concentrator mirror surfaces are in direct contact with each other and are configured to form a continuous transition, so that no additional deflection effects are introduced by the transition from the first concentrator to the second concentrator. This also has a positive effect on the efficiency.

In one embodiment, one or more focus points of the first concentrator are arranged in the area of the inlet opening of the second concentrator. This measure may also result in a high efficiency with regard to the performance of the illumination. It is particularly advantageous if the focus points of the reflecting parabolic surfaces for the first concentrator as CPC are arranged on the two sides of the cross section of the first inlet opening and the focus points of the reflecting parabolic surfaces for the second concentrator as CPC are arranged on the two sides of the cross section of the second outlet opening.

The following parameters for a concentrator unit, in which the first concentrator and the second concentrator are each configured as a CPC, may be derived from the conservation of the étendue. Furthermore, it is assumed for the sake of simplicity that the acceptance angle θ for the first concentrator and the second concentrator is approximately the same and that the refractive index is n=1. If the acceptance angle of both concentrators is known, the acceptance angle θ for the calculation may, for example, be determined as the arithmetic mean of the acceptance angle of the first concentrator and the acceptance angle of the second concentrator. Furthermore, the CPC is advantageously designed such that the radius of the first inlet opening is smaller than the radius of the second outlet opening. All dimensions given below are meant in the plane of the cross section.

In one embodiment, in the case that the first concentrator and the second concentrator are each configured as a CPC, the length Lᵥ of the concentrator unit is obtained from the equation

Lᵥ=(a_{c}+b_{c}+a_{d}+b_{d}) cot (θ)
wherein a_{c} is the radius of the outlet opening of the second concentrator, b_{c} is the radius of the inlet opening of the second concentrator, a_{d} is the radius of the inlet opening of the first concentrator, b_{d} is the radius of the outlet opening of the first concentrator, and θ is the acceptance angle.

In one embodiment, in the case that the first concentrator and the second concentrator are each configured as a CPC, the radius a_{c} of the outlet opening of the second concentrator is obtained from a_{c}=a_{d}+bᵥ sin (θ), wherein a_{d} is the radius of the inlet opening of the first concentrator, bᵥ is the length of the second section of the inlet opening of the second concentrator and θ is the acceptance angle.

The illuminance measured at the sample position decreases with distance from the second outlet opening. The extent of this divergence can be determined from the parameters of the illuminant as follows:

$$\frac{{a}_{d}}{{a}_{c}} = sin ( θ )$$

The exit angle Φ relative to the exit plane is therefore given by

$$ϕ = \frac{π}{2} - θ$$

The above object is also solved by an illumination device for the inspection of an object, wherein the illumination device comprises a light source and a concentrator unit as described above, wherein the light source and the concentrator unit are configured in such a way and the light source is arranged in the inlet opening of the first concentrator in such a way that that the light emitted by the light source is incident on the first concentrator and is transmitted by the concentrator unit to the object for the purpose of illuminating a predetermined inspection area of the object. In particular, if the light source is configured as a Lambertian radiator, a high level of efficiency is achieved by the above illumination device. In one embodiment, the light source is arranged in the first inlet opening in such a way that the angle of radiation of the light source is matched to the angle of acceptance of the first concentrator and a very large fraction of the radiation emitted by the light source (e.g. at least 90%, in particular at least 95% of the emitted radiation) is transmitted within the first concentrator towards the second concentrator.

In one embodiment of the illumination device, the light source and the concentrator unit are each configured in a line shape and the concentrator unit is configured to produce line-shaped illumination of the predetermined inspection area, wherein the light source comprises, for example, a plurality of LEDs or other Lambertian/collimated light sources arranged adjacently in a row. In a further embodiment, the light source comprises at least two adjacently arranged rows of LEDs. The rows are arranged adjacently in a direction perpendicular to the transverse direction and, for example, parallel to one another. This may be used to illuminate a wider inspection area, for example.

The above object is also solved by an inspection system for inspecting an object, wherein the inspection system comprises an illumination device as described above and a camera, wherein the illumination device is configured to illuminate a predetermined inspection area of the object, wherein the camera is configured to record images of the predetermined inspection area of the object along the observation path, wherein the object is arranged behind the second outlet opening of the concentrator unit in the direction of propagation of the light. The inspection system is arranged with all its elements (illumination device and camera) on the same first side of the object, e.g., above the object. In addition, an additional camera may optionally be used, which, for example in the case of a transparent object, observes the illuminated inspection area from the second side, which is opposite the first side. The inspection system has the same advantages as those already explained above for the concentrator unit and the illumination device. Therefore, it is referred to these. In one embodiment of the inspection system, in which the concentrator unit is line-shaped and the light source is line-shaped, the camera is configured as a line scan camera, for example as a TDI line scan camera.

In one embodiment, it is advantageous for the concentrator unit to be slightly tilted by the angle of inclination δ in one direction, so that the observation path of the camera extends perpendicular to the surface of the object. This makes it easier to avoid or compensate for any optical defects that may exist in the camera. The inclination is advantageous because the observation path extends laterally, at an angle to the axes of the two concentrators. In the embodiment, the angle of inclination δ of the concentrator unit to the normal on the surface of the object can be determined from the length Lᵥ of the concentrator unit, the radius b_{c} of the inlet opening of the second concentrator and the length bᵥ of the second section of the inlet opening of the second concentrator.

Further advantages, features and possible applications of the invention are described below with reference to an embodiment and the figures. All features described and/or depicted form the object of the present invention, even independently of their grouping in the claims and their cross-references.

Figures showing, schematically:

FIG. 1 a side view of an embodiment of an inspection system according to the invention,

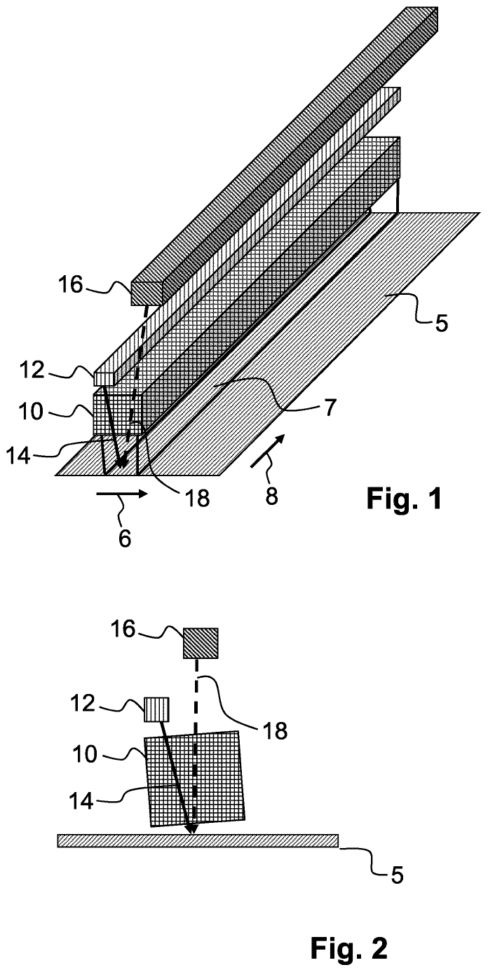

FIG. 2 a cross-sectional view of the embodiment of the inspection system according to FIG. 1,

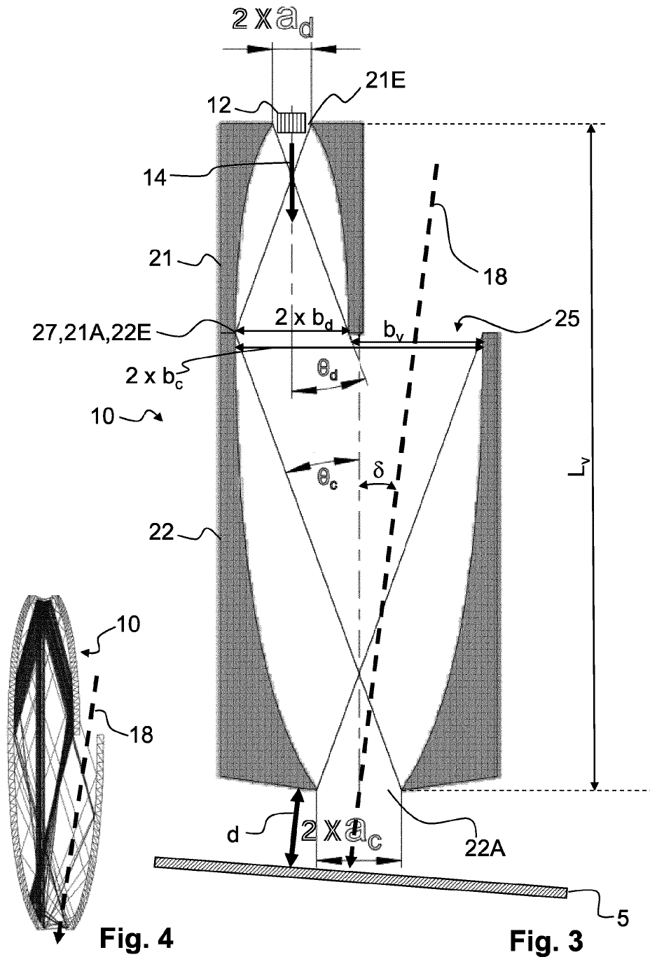

FIG. 3 a cross-sectional view of an embodiment of a concentrator unit with a light source and an object,

FIG. 4 the cross-sectional view of the concentrator unit according to FIG. 3 with a plurality of light beams running in the concentrator unit.

FIGS. 1 and 2 schematically show an embodiment of an inspection device that is arranged above an object 5. This is, for example, a printed circuit board that moves in the direction indicated by the arrow 6 underneath the inspection device and is illuminated along a line-shaped inspection area 7 that extends in a transverse direction (see arrow 8) running perpendicular to the direction of movement (arrow 6).

The inspection device consists of a line-shaped light source (12), which, for example, comprises a row of LEDs arranged adjacently in the transverse direction.

Furthermore, a concentrator unit 10 is provided, which transmits the light emitted by the light source 12 to the object 5 and illuminates the object in the inspection area 7. The concentrator unit 10 deflects the light provided by the light source 12 in such a way that the illumination output of the light source 12 is transported to the inspection area 7 with a high level of efficiency. The light path is illustrated in FIGS. 1 and 2 by means of the arrow 14. Furthermore, a line camera 16, for example a TDI camera, extending along the transverse direction (arrow 8) is provided, which is arranged on the side of the concentrator unit 10 opposite the object 5 and observes the object 5, in particular the illuminated inspection area 7, and records images. On the basis of the images of the inspection area 7 captured along the moving object 5, it is possible, for example, to analyze the quality of the object 5. In particular, it can be recognized in FIG. 2 that the concentrator unit 10 is arranged at an inclination to the normal on the surface of the object 5. This ensures that the camera 16 looks perpendicularly onto the surface of the object 5.

The structure of the concentrator unit 10 of the embodiment is explained in more detail below with reference to FIGS. 3 and 4, wherein these figures illustrate the cross-section parallel to the transport direction (arrow 6) and perpendicular to the transverse direction (arrow 8). The dimensions are given below with reference to this cross-section. The concentrator unit consists of a first concentrator 21 designed as a CPC and a second concentrator 22, also designed as a CPC. Both concentrators 21, 22 accordingly comprise two parabolic reflectors arranged opposite each other, as shown in FIGS. 3 and 4. The first concentrator comprises a first inlet opening 21E with a radius a_{d} and a first outlet opening 21A with a radius b_{d}. The second concentrator 22 has a second inlet opening 22E with a first section that has a length/diameter 2×b_{d}, and a second section bᵥ. In the following, the symbol b_{c} is also used for the length of the second inlet opening 22E, wherein 2×b_{c}=2×b_{d}+bᵥ. A second outlet opening 22A, which is also the outlet opening of the entire concentrator unit 10, has the radius a_{c}. Note that the subscript ‘x’ in the above paragraph and in FIG. 3 is intended to represent multiplication by the preceding factor (factor 2).

The first concentrator 21 is arranged in a scattering configuration and the second concentrator 22 is arranged in a light-collecting configuration. The acceptance angle, which is drawn in FIG. 3, is designated as θ_{d} for the first concentrator 21 and as θ_{c} for the second concentrator 22.

The second concentrator 22 is arranged directly behind the first concentrator 21 in the direction of propagation of the light (arrow 14), in such a way that the tangent at the inner reflecting surface at point 27 of the first outlet opening 21A of the first concentrator 21 and of the second inlet opening 22E of the second concentrator 22 are superimposed. The first concentrator 21 and the second concentrator 22 therefore merge into one another in such a way that no additional reflections of the light guided in the concentrator unit occur at the transition.

Furthermore, along the cross-section, the first concentrator 21 overlaps in the first section of the second inlet opening 22E of the second concentrator 22. The second section, which is adjacent along the cross-section, forms an opening 25 through which the camera 16 observes the illuminated inspection area 7 along the observation path 18. This makes it possible to take pictures of the inspection area 7 very easily. In this case, the observation path 18 is arranged inclined at an angle δ to the axes of the concentrators 21, 22, which are drawn by dashed-dotted lines. The object 5 comprises a normal with the same inclination, so that the camera 16 looks perpendicular to the object 8.

The light emitted by the light source 12 within the acceptance angle (2×θd), said light source being arranged in the first inlet opening 21E, is reflected at the parabolic inner surfaces of the first concentrator 21 in such a way that it enters the second inlet opening 22E of the second concentrator 22 via the outlet opening 21A of the first concentrator 21, from where it is directed towards the second outlet opening 22A of the second concentrator 22, where the light exits from the concentrator unit 10 and illuminates the object 5 arranged thereunder in the inspection area 7. The second outlet opening 22A is at a distance d from the surface of the object 5 (measured, other than indicated in FIG. 3, for example, at the center of the outlet opening 22A).

Using the equations given above, the concentrator unit can be adapted to the requirements of the respective inspection task. In this case, the design of the concentrator, which is shown in FIGS. 3 and 4 in cross-section, is identical along the entire transverse direction (arrow 8 in FIG. 1).

For example, the concentrator unit 10 may be dimensioned so that the radius a_{d} of the first inlet opening 21E of the first concentrator is 2.5 mm. The radius a_{c} of the second outlet opening 22A of the second concentrator may, for example, be 3 mm. The acceptance angle θ_{d} of the first concentrator 21 may, for example, be 15°, while the acceptance angle θ_{c} of the second concentrator 22 may be chosen as 20°. For the combination of two CPCs as described above, this results in a length of the concentrator unit Lᵥ of about 110 mm and a width bᵥ of the opening 25 for the observation path (arrow 18) of the camera 16 of 16 mm. The concentrator unit may have a transversal dimension (arrow 18) of 200 mm to 500 mm. In this example, the distance d of the object 5 from the second outlet opening is 3 mm.

FIG. 4 illustrates the course of some light beams in the reflector unit 10.

The concentrator unit 10 according to the invention, the illumination device, which is composed of the concentrator unit 10 and the light source 12, and the inspection device, which comprises the illumination device and the camera 16, may provide a simple means for inspecting an object, whereby the performance of the light source 12 can be applied to the object with a very high efficiency.

1. A nonimaging concentrator unit comprising
a first two-dimensional nonimaging concentrator having a first inlet opening and a first outlet opening, and
a second two-dimensional nonimaging concentrator having a second inlet opening, the cross section of which comprises a first section and an adjacent second section, and a second outlet opening,
wherein along the direction of propagation of light the first concentrator in an incident light scattering configuration and the second concentrator in an incident light collecting configuration are arranged one after the other,
wherein the second concentrator is arranged behind the first concentrator in such a way that the first concentrator overlaps the second inlet opening in the first section only so that the light exiting from the first outlet opening enters the second inlet opening in the area of the first section only, and
wherein an optical observation path extends through the second section of the second inlet opening and the second outlet opening.

2. The concentrator unit according to claim 1, wherein the non-imaging concentrator unit is configured in a line-shaped manner such that the first inlet opening, the first outlet opening, the second inlet opening, and the second outlet opening each comprise a corresponding slit shape extending in a transverse direction.

3. The concentrator unit according to claim 1, wherein the second concentrator is arranged directly behind the first concentrator in the direction of propagation of the light in such a way that the first concentrator overlaps with the second inlet opening in the first section of the second inlet opening.

4. The concentrator unit according to claim 1, wherein the light-deflecting devices of the first concentrator and the second concentrator comprise reflective surfaces and/or transparent bodies.

5. The concentrator unit according to claim 1, wherein at least one concentrator of the first concentrator and of the second concentrator is configured as a Compound Parabolic Concentrator.

6. The concentrator unit according to claim 1, wherein the first concentrator is arranged adjacent to the second concentrator in such a way that a first tangent at a first point of contact on an inner concentrator mirror surface of the first concentrator and a second tangent at a second point of contact on an inner concentrator mirror surface of the second concentrator are superimposed.

7. The concentrator unit according to claim 1, wherein one or more focus points of the first concentrator are arranged in the area of the inlet opening of the second concentrator.

8. The concentrator unit according to claim 1, wherein, in the case where the first concentrator and the second concentrator are each configured as a CPC, the length Lᵥ of the concentrator unit is obtained from the equation
Lᵥ=(a_{c}+b_{c}+a_{d}+b_{d}) cot (θ)
wherein a_{c} is the radius of the outlet opening of the second concentrator, b_{c} is the radius of the inlet opening of the second concentrator, a_{d} is the radius of the inlet opening of the first concentrator, b_{d} is the radius of the outlet opening of the first concentrator, and q is the acceptance angle.

9. The concentrator unit according to claim 1, wherein, when the first concentrator and the second concentrator are each configured as a Compound Parabolic Concentrator (CPC), the radius a_{c} of the outlet opening of the second concentrator is obtained from a_{c}=a_{d}+bᵥ sin (θ), wherein a_{d} is the radius of the inlet opening of the first concentrator, bᵥ is the length of the second section of the inlet opening of the second concentrator, and q is the acceptance angle.

10. An illumination device for the inspection of an object, comprising:
a light source, and
a concentrator unit according to claim 1,
wherein the light source and the concentrator unit are configured in such a way and the light source is arranged in the inlet opening of the first concentrator in such a way that the light emitted by the light source is incident on the first concentrator and is transmitted by the concentrator unit to the object for the purpose of illuminating a predetermined inspection area of the object.

11. The illumination device according to claim 10, wherein the light source and the concentrator unit are each formed in a line shape and the concentrator unit is configured to produce line-shaped illumination of the predetermined inspection area.

12. An inspection system for inspecting an object, comprising:
an illumination device according to claim 10, and
a camera,
wherein the illumination device is configured to illuminate a predetermined inspection area of the object, and
wherein the camera is configured to record images of the predetermined inspection area of the object along the observation path, the object being arranged behind the second outlet opening of the concentrator unit in the direction of propagation of the light.

13. The inspection system according to claim 12, wherein the camera is configured as a line scan camera.

14. The inspection system according to claim 12, wherein the angle of inclination d of the concentrator unit to the normal on the surface of the object can be determined from the length Lᵥ of the concentrator unit, the radius b_{c} of the inlet opening of the second concentrator and the length bᵥ of the second section of the inlet opening of the second concentrator.

15. The illumination device according to claim 11, wherein the light source comprises a plurality of LEDs arranged adjacently in a row.
